(19) United States
(12) Patent Application Publication
(10) Pub. No.: US 2026/0357781 A1
(43) Pub. Date: Nov. 12, 2026

(54) Hydraulic Motor with Roller Pins for Control of an Orbit Ring

(71) Applicant: Parker-Hannifin Corporation, Cleveland, OH (US)

(72) Inventor: Kenneth T. Gilbert, Bristol, TN (US)

(21) Appl. No.: 19/461,976

(22) Filed: Jan. 28, 2026

Related U.S. Application Data
(60) Provisional application No. 63/800,743, filed on May 6, 2025.

(51) Int. Cl. F03C 2/08; F04C 2/08; F04C 2/10; F04C 2/113

(52) U.S. Cl. CPC F03C 2/08; F04C 2/084; F04C 2/10; F04C 2/103; F04C 2/113

(57) ABSTRACT

An example hydraulic motor includes: a first wear plate having pockets; a rotating group comprising: (i) an orbit ring having holes, (ii) a plurality of vanes, and (iii) a rotor mounted within the orbit ring; a second wear plate having respective holes; and roller pins respectively mounted within the pockets of the first wear plate, through the holes in the orbit ring, and within the respective holes in the second wear plate, wherein the orbit ring orbits in a rotational direction, the rotor rotates about an axis thereof in an opposite rotational direction, and the roller pins roll within the plurality of pockets of the first wear plate, the plurality of holes in the orbit ring, and the respective plurality of holes in the second wear plate as the orbit ring orbits.

### CROSS REFERENCE TO RELATED APPLICATION

The present application claims priority to U.S. Provisional Patent Application No. 63/800,743, filed on May 6, 2025, the entire contents of which are herein incorporated by reference as if fully set forth in this description.

### BACKGROUND

Hydraulic motors can be configured to receive fluid as an input and provide high torque rotational movement as an output. Such hydraulic motors can include gear sets configured to cooperatively define fluid chambers. The chambers expand when hydraulically connected to a source (e.g., a pump) of fluid and contract when connected to a drain that returns the fluid to the source or a fluid reservoir. The expansion and contraction of the fluid chambers causes the rotational movement.

Some conventional hydraulic motors may include a component that has an internally ground cycloidal surface in the rotating group. Such internal grinding operation is more expensive to produce than an externally ground cycloidal surface.

Further, such conventional hydraulic motors have a rotor that is configured to rotate about its own axis and orbit at the same time. This necessitates the use of a drive link between the rotor and an output shaft of the hydraulic motor to eliminate the orbiting motion at the output shaft. As a result, the output shaft is typically short, and its supporting bearings carry a large load.

It may thus be desirable to have a hydraulic motor that is configured with a component having an externally ground cycloidal surface rather than an internal cycloidal surface, while also eliminating the drive link. It is with respect to these and other considerations that the disclosure made herein is presented.

### SUMMARY

The present disclosure describes implementations that relate to a hydraulic motor with roller pins for control of an orbit ring.

In a first example implementation, this disclosure describes a hydraulic motor. The hydraulic motor includes: a first wear plate having pockets; a rotating group comprising: (i) an orbit ring having holes, (ii) a plurality of vanes, and (iii) a rotor mounted within the orbit ring; a second wear plate having respective holes; and roller pins respectively mounted within the pockets of the first wear plate, through the holes in the orbit ring, and within the respective holes in the second wear plate, wherein the orbit ring orbits in a rotational direction, the rotor rotates about an axis thereof in an opposite rotational direction, and the roller pins roll within the plurality of pockets of the first wear plate, the plurality of holes in the orbit ring, and the respective plurality of holes in the second wear plate as the orbit ring orbits.

In a second example implementation, this disclosure describes a hydraulic system including the hydraulic motor of the first example implementation.

In a third example implementation, the present disclosure describes a method of operating the hydraulic motor of the first example implementation or the hydraulic system of the second example implementation.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1A illustrates a perspective view of a hydraulic motor in a hydraulic system, according to an example implementation.

FIG. 1B illustrates a front view of the hydraulic motor of FIG. 1A, according to an example implementation.

FIG. 1C illustrates a cross-sectional side view of the hydraulic motor of FIGS. 1A-1B, according to an example implementation.

FIG. 1D illustrates an exploded perspective view of the hydraulic motor of FIGS. 1A-1C, according to an example implementation.

FIG. 2 illustrates a perspective view of a port block of the hydraulic motor of FIGS. 1A-1D, according to an example implementation.

FIG. 3 illustrates a partial perspective view of the hydraulic motor of FIGS. 1A-1D showing the port block of FIG. 2 and a wear plate, according to an example implementation.

FIG. 4A illustrates a partial perspective view of the hydraulic motor of FIGS. 1A-1D showing the port block of FIG. 2, the wear plate of FIG. 3, and a spacer with a valve disk disposed therein, according to an example implementation.

FIG. 4B illustrates a rear view of the hydraulic motor of FIG. 4A, according to an example implementation.

FIG. 5A illustrates a partial perspective view of the hydraulic motor of FIGS. 1A-1D showing the port block of FIG. 2, the wear plate of FIG. 3, the spacer of FIGS. 4A-4B, another wear plate, and roller pins, according to an example implementation.

FIG. 5B illustrates a rear view of the hydraulic motor of FIG. 5A, according to an example implementation.

FIG. 6A illustrates a partial perspective view of the hydraulic motor of FIGS. 1A-1D showing the port block of FIG. 2, the wear plate of FIG. 3, the spacer of FIGS. 4A-4B, the wear plate of FIGS. 5A-5B, a locating ring and a rotating group disposed therein, according to an example implementation.

FIG. 6B illustrates a rear view of the hydraulic motor of FIG. 6A, according to an example implementation.

FIG. 7 illustrates a partial perspective view of the hydraulic motor of FIGS. 1A-1D showing the port block of FIG. 2, the wear plate of FIG. 3, the spacer of FIGS. 4A-4B, the wear plate of FIGS. 5A-5B, the locating ring 110 of FIGS. 6A-6B, and another wear plate, according to an example implementation.

FIG. 8 illustrates an enlarged view of a portion of the cross-sectional view in FIG. 1C, according to an example implementation.

FIG. 9 illustrates another enlarged view of a portion of the cross-sectional view in FIG. 1C showing configuration of a check valve in an end cover of the hydraulic motor of FIGS. 1A-1D, according to an example implementation.

### DETAILED DESCRIPTION

Within examples, disclosed herein is a hydraulic motor that allows for a through output shaft and a shorter overall motor assembly without drive links, among other features.

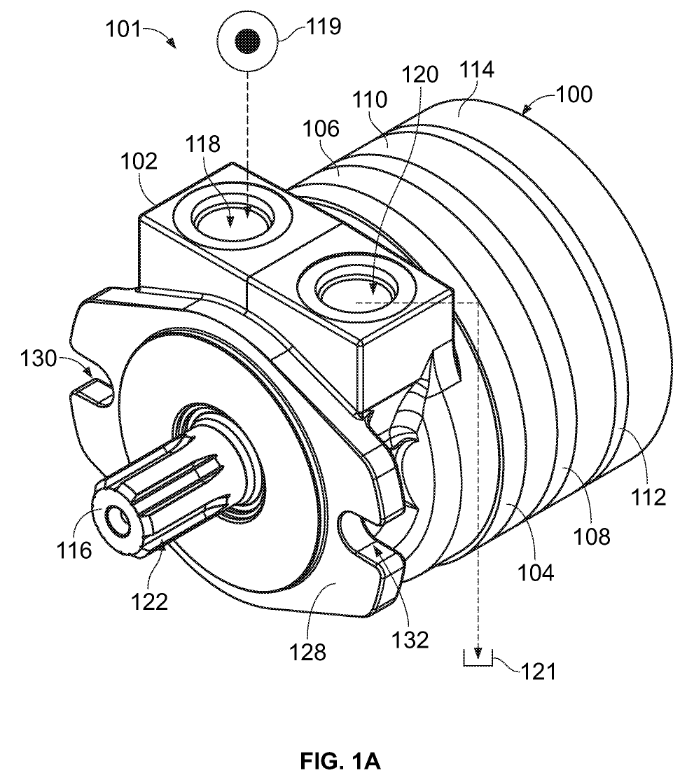

FIG. 1A illustrates a perspective view of a hydraulic motor 100 in a hydraulic system 101, FIG. 1B illustrates a front view of the hydraulic motor 100, FIG. 1C illustrates a cross-sectional side view of the hydraulic motor 100, and FIG. 1D illustrates an exploded perspective view of the hydraulic motor 100, according to an example implementation. FIGS. 1A-1D are described together.

The hydraulic motor 100 includes a housing or port block 102, a wear plate 104, a spacer 106, a wear plate 108, a locating ring 110, a wear plate 112, an end cover 114, and an output shaft 116. The spacer 106 is axially interposed between the wear plate 104 and the wear plate 108, and the locating ring 110 is axially interposed between the wear plate 108 and the wear plate 112, as shown. In some examples, the features of the wear plate 112 can be integrated into the end cover 114. So, there could be one component that operates as the wear plate 112 and the end cover 114.

The port block 102 has a first port 118 and a second port 120. The hydraulic motor 100 is configured as a bi-directional motor enabling the output shaft 116 to rotate in either direction (e.g., clockwise or counter-clockwise) based on which port receives high pressure fluid from a source 119 of fluid (e.g., pump) and which port discharges low pressure fluid back to the source 119 or to a fluid reservoir 121.

As such, either of the first port 118 or the second port 120 can be an inlet port while the other can be an outlet port. For example, if fluid is received from the source 119 of fluid at the first port 118 and then fluid is discharged from the second port 120, the output shaft 116 rotates in a first rotational direction (e.g., counter-clockwise). Conversely, if fluid is received from the source 119 of fluid at the second port 120 and then fluid is discharged from the first port 118, the output shaft 116 rotates in a second rotational direction (e.g., clockwise) opposite the first rotational direction.

In the description below, the first port 118 is used as the inlet port fluidly coupled to the source 119, while the second port 120 is used as the outlet port fluidly coupled to the fluid reservoir 121. However, it should be understood that this configuration can be reversed and that all high pressure galleries, windows, ports, etc. can be switched to be at low pressure, while the low pressure galleries, windows, ports, etc. can be switched to be at high pressure if the rotation direction of the output shaft 116 is to be reversed.

As shown in FIGS. 1A, 1D, the output shaft 116 can have splines 122 at its distal end to enable the output shaft 116 to engage and drive a wheel or gearbox, for example. The cutting plane of the cross-sectional view of FIG. 1C passes through the longitudinal axis of the output shaft 116 and bisects (passes in between) the ports 118, 120 of the port block 102. As shown in FIG. 1C, the output shaft 116 is supported via a first bearing 124 (distal bearing) located in the port block 102 and a second bearing 126 (proximal bearing) located in the end cover 114. A shaft seal assembly 127 shown in FIGS. 1C, 1D may be used to prevent leakage to an external environment of the hydraulic motor 100.

Reference to “distal” and “proximal” herein is not intended to imply a specific orientation of components of the hydraulic motor 100 relative to any surrounding environment. Instead, these directional terms are intended to facilitate a description of the interrelationship between the several components of the hydraulic motor 100 and their function.

The port block 102 has a mounting flange 128 having mounting holes or recesses, such as recess 130 and recess 132 shown in FIG. 1A, for example. The mounting flange 128 and recesses 130, 132 enable mounting the hydraulic motor 100 to a vehicle or frame of any machine, for example. Further a plurality of clamp bolts 134 (e.g., seven bolts in this example) are used to clamp all stationary (non-rotating) parts of the hydraulic motor 100 together to contain pressure and to transfer torque, radial loads, and thrust loads between the output shaft 116 and the mounting interfaces of the port block 102, and then to the frame of the machine to which the hydraulic motor 100 is mounted.

As shown in FIG. 1D, the hydraulic motor 100 further includes a rotating group 136 configured to be disposed within the locating ring 110. The rotating group 136 includes an orbit ring 138, a plurality of vanes 140 (e.g., cylinders), a rotor 142, and a plurality of roller pins 144. The hydraulic motor 100 also includes a valve disk 146 that is disposed, and rotatable, within the spacer 106.

Multiple seals (e.g., elastomer seals) are disposed between the various components as shown in FIG. 1D (e.g., seal 148, seal 150, seal 152, seals 154, seal 156, etc.) to prevent leakage to an external environment of the hydraulic motor 100.

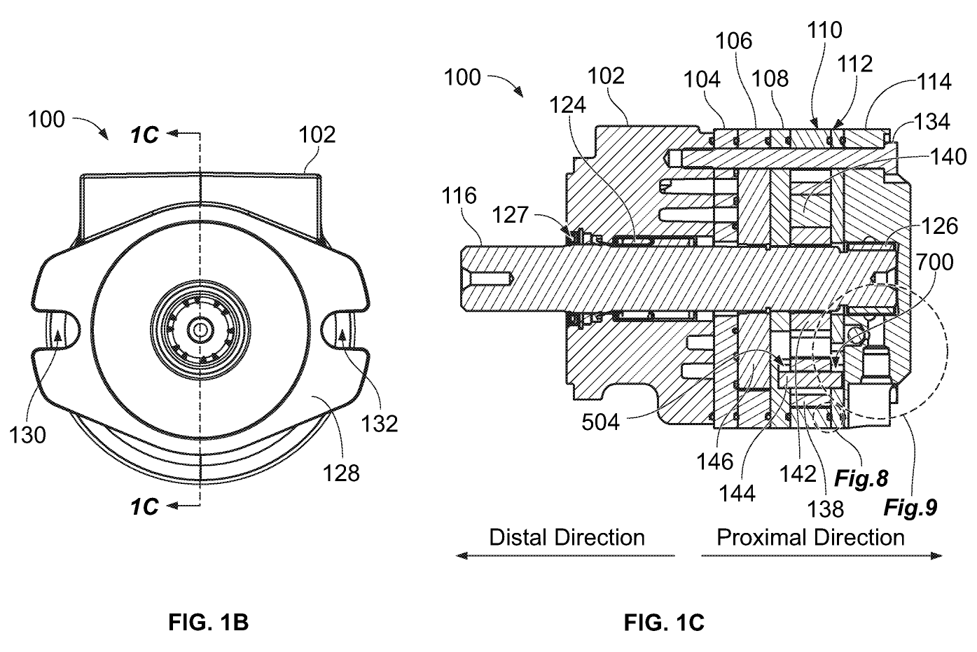

FIG. 2 illustrates a perspective view of the port block 102, according to an example implementation. FIG. 2 particularly shows details of a proximal end of the port block 102.

As shown, the port block 102 can have multiple concentric rings formed therein such as ring 200 and ring 202. Annular fluid galleries are formed in the annular space between the rings. For example, the port block 102 can have a fluid gallery 204 formed between the ring 200 and interior surface of the port block 102, and another fluid gallery 206 is formed between the ring 200 and the ring 202. The port block 102 also have bolt holes, such as bolt hole 208, through which the clamp bolts 134 are disposed.

The fluid gallery 204 is fluidly coupled to the first port 118, while the fluid gallery 206 is fluidly coupled to the second port 120. Thus, if high pressure fluid is received at the first port 118, such fluid is communicated to the fluid gallery 204. Return, low pressure, fluid is provided through the fluid gallery 206 to the second port 120 to be discharged therefrom. High pressure fluid in the fluid gallery 204 is then provided through slots in wear plate 104.

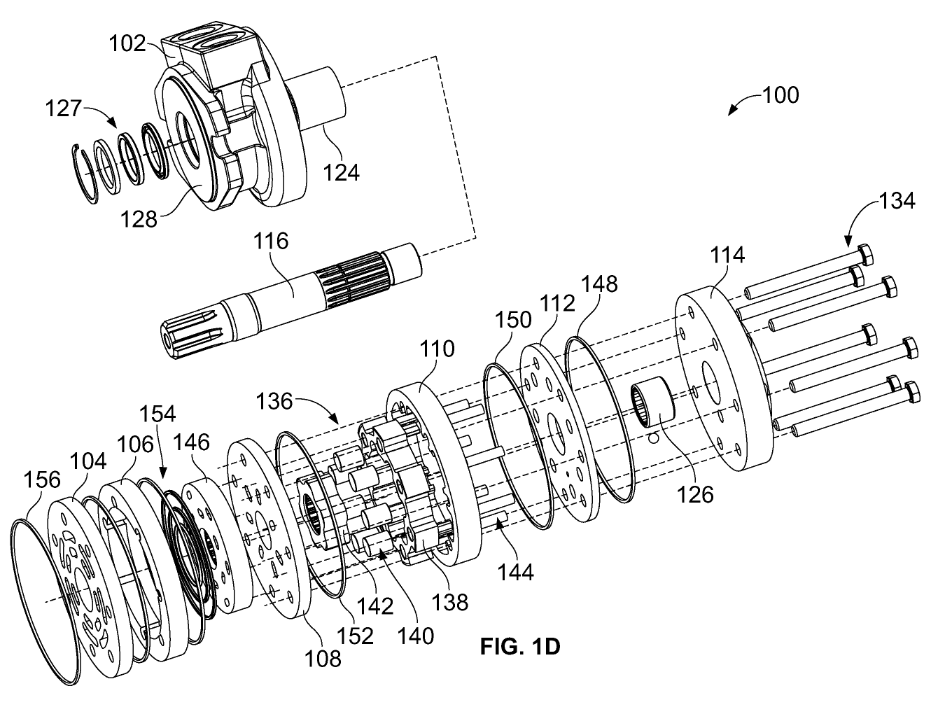

FIG. 3 illustrates a partial perspective view of the hydraulic motor 100 showing the port block 102 and the wear plate 104, according to an example implementation. FIG. 3 particularly shows details of a proximal end of the wear plate 104. The wear plate 104 is a stationary component and has bolt holes, such as bolt hole 304, through which the clamp bolts 134 are disposed.

The wear plate 104 has concentric sets of slots formed in a circular array in the wear plate 104. For example, the wear plate 104 has a first set of slots, such as slot 300, that are fluidly coupled to the fluid gallery 204 of the port block 102. The reference number “300” is used herein to refer to the first set of slots (outer or radially outward slots) collectively. The first set of slots 300 thus receive the high pressure fluid from the fluid gallery 204.

The wear plate 104 also includes a second set of slots, such as slot 302, that are formed radially inward from the first set of slots 300 and are fluidly coupled to the fluid gallery 206 of the port block 102. The reference number “302” is used herein to refer to the second set of slots (inner or radially inward slots) collectively. The second set of slots 302 thus provide return fluid to the fluid gallery 206.

As shown in the example implementation of FIG. 3, the slots 300, 302 are formed as arcuate through-holes in the wear plate 104. However, other shapes (e.g., circular holes, rectangular holes, or other geometric shapes) could be used. In one example, the slots of the first set of slots 300 have a larger angular span compared to respective slots of the second sets of slots 302, as shown in FIG. 3.

Fluid provided to the first set of slots 300 from the fluid gallery 204 (high pressure fluid) is then communicated into respective high-pressure windows in the valve disk 146. In some examples, the wear plate 104 might not be used, and fluid can be communicated directly between the port block 102 and the valve disk 146. In these examples, the spacer 106 may be axially interposed between, and directly interfacing with, the port block 102 and the wear plate 108.

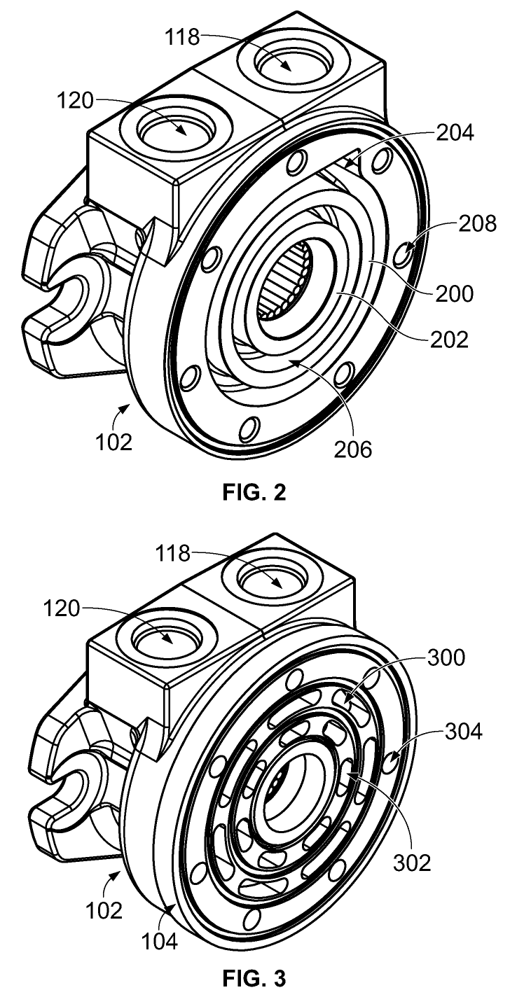

FIG. 4A illustrates a partial perspective view of the hydraulic motor 100 showing the port block 102, the wear plate 104, and the spacer 106 with the valve disk 146 disposed therein, and FIG. 4B illustrates a rear view of the hydraulic motor 100 of FIG. 4A, according to an example implementation. FIGS. 4A-4B particularly shows details of a proximal end of the valve disk 146.

The valve disk 146 rotates with the output shaft 116. For example, the output shaft 116 can have splines 400 and the valve disk 146 can have respective internal splines that engage the splines 400, thereby causing the valve disk 146 to rotate with the output shaft 116 inside the spacer 106. Thus, while the spacer 106 is a stationary component, and thus has bolt holes, such as bolt hole 402, through which the clamp bolts 134 are disposed, the clamp bolts do not go through the valve disk 146.

As shown in FIG. 4B, for example, the valve disk 146 has two sets of interleaving windows. Particularly, the valve disk 146 can have a first set of windows 404 (e.g., six windows: window 404a, window 404b, window 404c, window 404d, window 404e, window 404f) disposed in a circular array in the valve disk 146. The valve disk 146 also has a second set of windows 406 (e.g., six windows: window 406a, window 406b, window 406c, window 406d, window 406e, window 406f) disposed in a circular array in the valve disk. The first set of windows 404 are interleaved with the second set of windows 406.

The term “interleaved” is used here to indicate that one window of the first set of windows 404 is circumferentially- or circularly-interposed between two windows of the second set of windows 406 and vice versa (e.g., each windows of the second set of windows 406 is circumferentially- or circularly-interposed between two windows of the first set of windows 404). For example, the window 404a is or circularly-interposed between the windows 406f, 406a, and the window 406a is or circularly-interposed between the windows 404a, 404b, and so on.

The windows of the first set of windows 404 are longer in a radial direction compared to respective windows of the second set of windows 406 as depicted in FIG. 4B. In an example implementation, the windows 404a-404f can each be formed to be tee-shaped (T-shaped) having a tangential portion and a radial portion. Referring to the window 404b, for example, it has a tangential portion 408 and a radial portion 410. Respective tangential portions of the windows 404a-404f extend these windows radially compared to the windows 406a-406f, for example.

As the windows 404a-404f extend longer in the radial direction (e.g., because of the tangential portions), they are in fluid communication with, or are fluidly coupled to, the first set of slots 300 of the wear plate 104. As mentioned above, the first set of slots 300 are fluidly coupled to the fluid gallery 204 of the port block 102, and thus receive the high pressure fluid from the fluid gallery 204. Thus, the windows 404a-404f also have access to or receive the high pressure fluid of the fluid gallery 204.

On the other hand, as the windows 406a-406f are radially shorter, they are in fluid communication with, or are fluidly coupled to, the second set of slots 302 of the wear plate 104, but not in fluid communication with the first set of slots 300. With this configuration, the windows 406a-406f provide low pressure return fluid to the second set of slots 302, then to the fluid gallery 206 to be discharged through the second port 120.

As the valve disk 146 rotates, its windows (the first set of windows 404 and the second set of windows 406) pass in front of ports formed in the wear plate 108 in a sequential manner.

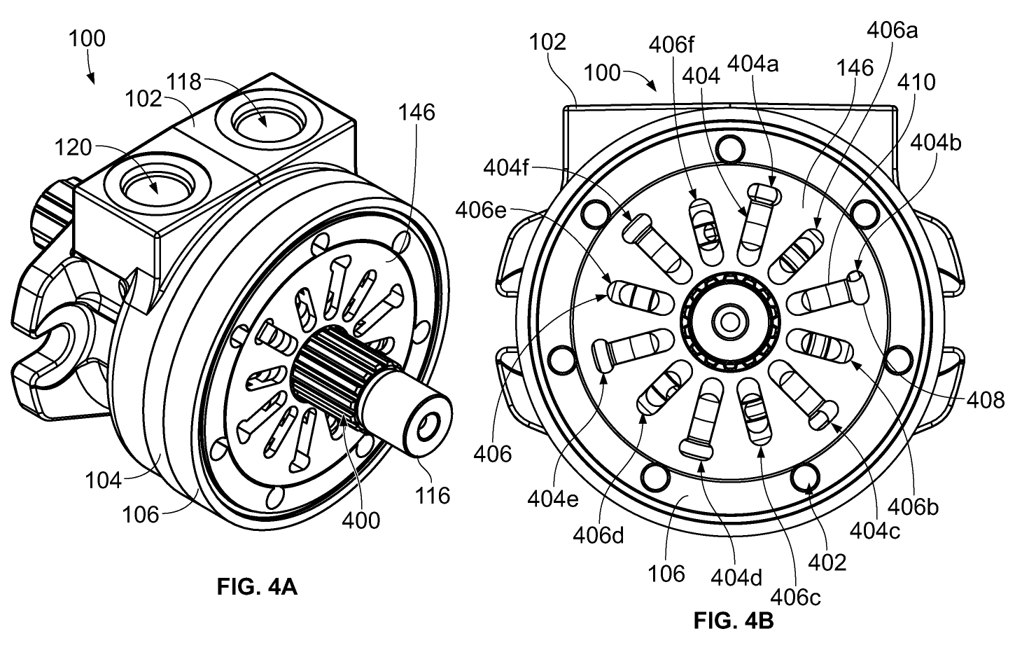

FIG. 5A illustrates a partial perspective view of the hydraulic motor 100 showing the port block 102, the wear plate 104, the spacer 106, the wear plate 108, and the roller pins 144 and FIG. 5B illustrates a rear view of the hydraulic motor 100 of FIG. 5A, according to an example implementation. FIGS. 5A-5B particularly shows details of a proximal end of the wear plate 108.

The wear plate 108 is a stationary component, and thus has bolt holes, such as bolt hole 500, through which the clamp bolts 134 are disposed.

The wear plate 108 has a plurality of ports 502. Particularly, in this example implementation, the wear plate 108 is configured to have an additional port compared to the number of windows in the first set of windows 404 or the number of windows of the second set of windows 406 of the valve disk 146. For example, if the number of windows of the first set of windows 404 or the second set of windows 406 is “n” is six, then the wear plate 108 has “n+1” ports. In the example implementation in the figures, there the first set of windows 404 are six windows and then second set of windows 406 are also six windows, and thus the wear plate 108 has seven ports.

In particular, the wear plate 108 has port 502a, port 502b, port 502c, port 502d, port 502e, port 502f, and port 502g. The port 502g is disposed at a center line of the wear plate 108, while the three ports 502a, 502b, 502c are formed on one side of the center line (on the right side of the port 502g in FIG. 5B), and the three ports 502d, 502e, 502f are formed on the other side of the center line (on the left side of the port 502g in FIG. 5B).

As the valve disk 146 rotates, its windows (the first set of windows 404 and the second set of windows 406) pass in front of ports formed in the wear plate 108 in a sequential manner such that each port of the ports 502 is sequentially exposed to high pressure fluid (when a window of the first set of windows 404 pass in front of the port), then neutral pressure fluid (neither the high pressure fluid nor the low pressure fluid when the space between two windows of the valve disk 146 pass in front of the port), then low pressure fluid (when a window of the second set of windows 406 pass in front of the port).

For example, in the particular rotary position of the valve disk 146 in FIG. 5B, the high-pressure windows (the windows 404a, 404b, 404c) expose a subset of ports, and particularly three ports: the ports 502c, 502b, 502a on the right side of the wear plate 108 to high pressure fluid. On the other hand, the low-pressure windows (the windows 406d, 406e, 406f) expose another subset of ports, and particularly three ports: the ports 502f, 502e, 502d on the left side of the wear plate 108 to low pressure fluid. The port 502g is exposed to neutral pressure as it is not exposed to any window of the first set of windows 404 or the second set of windows 406.

As the valve disk 146 rotates, these pressure levels to which each port of the ports 502 is exposed changes. As such, rotation of the valve disk 146 creates a rotating pressure field.

Further, as shown in FIG. 5A, for example, the hydraulic motor 100 has the plurality of roller pins 144 (see also FIGS. 1C-1D). Although seven roller pins are shown, more of fewer roller pins can be used based on the load to which the hydraulic motor 100 is subjected to.

Respective first ends (distal ends) of the roller pins are received within respective pockets 504 (e.g., circular blind holes) formed in the wear plate 108. For example, referring to FIG. 1C, one of the roller pins 144 is shown received in one of the pockets 504. The roller pins 144 are configured to roll within the pockets 504 and respective pockets in the wear plate 112. The roller pins 144 control the orbiting of the orbit ring 138 as high pressure fluid is provided to chambers within the rotating group 136. As mentioned above, in some examples, the features of the wear plate 112 can be integrated into the end cover 114. The roller pins 144 can be supported in holes or pockets in the end cover.

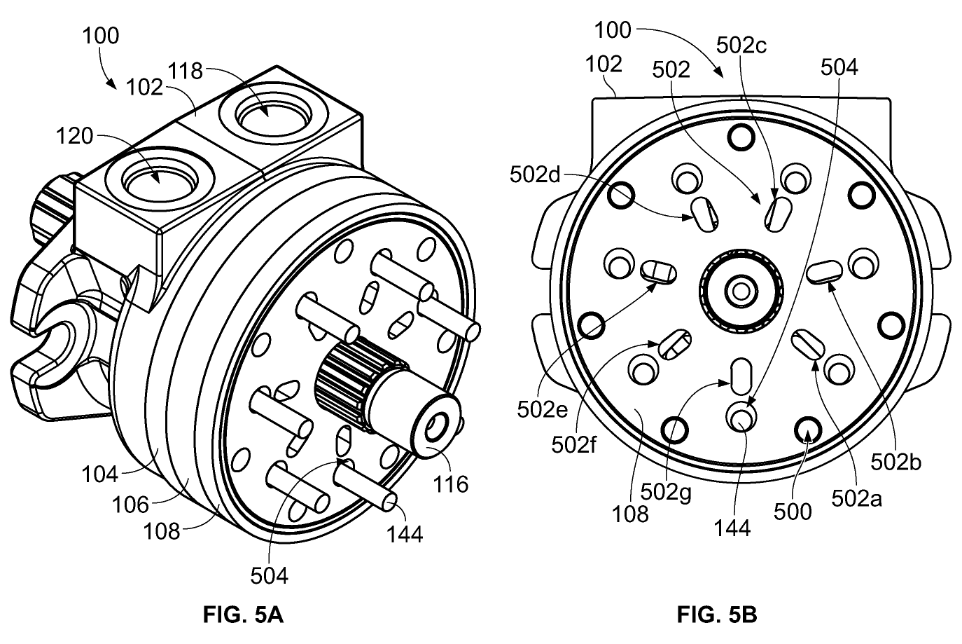

FIG. 6A illustrates a partial perspective view of the hydraulic motor 100 showing the port block 102, the wear plate 104, the spacer 106, the wear plate 108, the locating ring 110 and the rotating group 136 disposed therein, and FIG. 6B illustrates a rear view of the hydraulic motor 100 of FIG. 6A, according to an example implementation. FIGS. 6A-6B particularly shows details of the rotating group 136.

The locating ring 110 is a stationary component, and thus has bolt holes, such as bolt hole 600, through which the clamp bolts 134 are disposed. The rotating group 136 is, however, not stationary and the clamp bolts 134 do not go therethrough. As shown, the hydraulic motor 100 has seven vanes 140, and the rotor 142 has six lobes (e.g., cycloidal exterior surface of the rotor 142 forming the six lobes). The vanes 140 are disposed in vane pockets formed in the orbit ring 138 and are configured to interact with the lobes of the rotor 142.

As shown in FIG. 6B, a plurality of fluid pockets or chambers are formed between orbit ring 138, the vanes 140, and rotor 142, such as chamber 602a, chamber 602b, chamber 602c, chamber 602d, chamber 602e, chamber 602f, and chamber 602g. The high pressure fluid in the ports 502c, 502b, 502a (see FIG. 5B) cause the chambers 602a, 602b, 602c on the right side in FIG. 6B to expand. Concurrently, the chambers 602d, 602e, 602f on the left side in FIG. 6B contract, forcing low pressure fluid to flow into the ports 502d, 502e, 502f (see FIG. 5B).

As shown, the roller pins 144 pass, or are disposed, through respective holes such as hole 604 in the orbit ring 138. Reference number “604” is used herein to encompass all the respective holes in the orbit ring 138 through which the roller pins 144 are disposed.

As the chambers 602a, 602b, 602c (high-pressure chambers) expand and the chambers 602d, 602e, 602f (low-pressure chambers) contract, the orbit ring 138 orbits in a first rotational direction (e.g., counterclockwise direction), eccentrically relative to the longitudinal axis of the rotor 142 and the output shaft 116. The rotation of the orbit ring 138 and the contact between the orbit ring 138, the vanes 140, and the rotor 142 force the rotor 142 to rotate in a an opposite rotational direction (e.g., clockwise direction). In other words, as the chambers 602a, 602b, 602c (high-pressure chambers) expand, and because the rotor 142 is rotatably coupled to the output shaft 116, the reaction fluid force causes the orbit ring 138 to orbit or oscillate, and the vanes 140 then cause the rotor 142 to rotate about its own axis, causing the output shaft 116 to rotate.

As the orbit ring 138 orbits, it does not touch the interior surface of the locating ring 110. The rotor 142 does not orbit. It rotates about its own axis (the longitudinal axis of the output shaft 116) only, thereby causing the output shaft 116 to rotate (due to spline engagement between the rotor 142 and the splines 400 of the output shaft 116) without the need for a drive link as in conventional motors.

The low-pressure fluid in the chambers 602d, 602e, 602f flows into the ports 502d, 502e, 502f shown in FIG. 5B, then into the second set of windows 406 (see FIG. 4B) in the valve disk 146. From the second set of windows 406, fluid flows through the second set of slots 302 in the wear plate 104 (see FIG. 3) into the fluid gallery 206 (see FIG. 2), and is then discharged through the second port 120 of the port block 102.

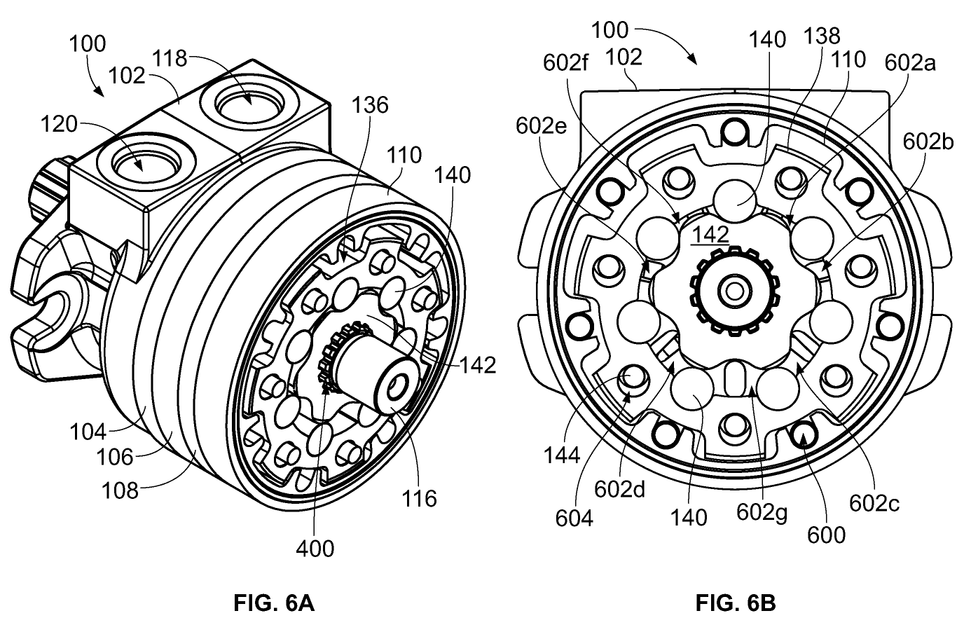

FIG. 7 illustrates a partial perspective view of the hydraulic motor 100 showing the port block 102, the wear plate 104, the spacer 106, the wear plate 108, the locating ring 110, and the wear plate 112, according to an example implementation. Referring to FIGS. 1C, 7 together, while respective first ends (distal ends) of the roller pins 144 are received in the pockets 504 (blind holes) in the wear plate 108, the respective second ends (proximal ends) of the roller pins 144 are received in holes 700 (e.g., through-holes) formed in the wear plate 112. As mentioned above, in some examples, the features of the wear plate 112 can be integrated into the end cover 114. The roller pins 144 can be supported in holes or pockets in the end cover.

Referring to FIGS. 6A-6B, 7 together, the motion profile of the orbit ring 138 is controlled by the contact between the orbit ring 138, the vanes 140, the rotor 142, the roller pins 144, and the wear plates 108, 112. The roller pins 144 contact the surfaces bounding the pockets 504 in the wear plate 108 and the surfaces bounding the holes 700 in the wear plate 112, and the surfaces bounding the holes 604 of the orbit ring 138.

The roller pins 144 each has a consistent diameter along its length. Notably, diameters of the pockets 504, the holes 604, and the holes 700 are all the same and are equal to the sum of the diameter of the roller pins 144 and the eccentricity of the orbiting profile of the orbit ring 138 (relative to the longitudinal axis of the output shaft 116). The wear plates 108, 112 engage the roller pins 144 near each end of the roller pins (see, e.g., FIG. 1C), and the orbit ring 138 engages the roller pins 144 at the midpoint of their length. The pockets 504 in the wear plate 108 are coaxial to the holes 700 of the wear plate 112, and the holes 604 in the orbit ring 138 match the pattern of the pockets 504 and the holes 700 in the wear plates 108, 112, respectively.

However, the fit between the orbit ring 138, the vanes 140, and the rotor 142 forces the pattern of holes 604 in the orbit ring 138 to be eccentric to the pattern of pockets 504 and the holes 700 in the wear plates 108, 112 by a distance equal to the clearance between the roller pins 144 and the holes 604 in the orbit ring 138, the pockets 504, and the holes 700 of the wear plates 108, 112. This configuration allows the roller pins 144 to roll around the pockets 504, and the holes 604, 700 as the orbit ring 138 orbits without sliding. Particularly, the rolling of the roller pins 144 generates the orbital motion of the orbit ring 138 without inducing sliding between the roller pins 144 and the wear plates 108, 112 or the orbit ring 138, thus minimizing friction on the roller pins 144.

As mentioned above with respect to FIG. 1C, the output shaft 116 is positioned and supported by the first bearing 124 in a central bore of the port block 102 and the second bearing 126 in a central bore of the end cover 114. The plurality of clamp bolts 134 clamp all stationary parts of the hydraulic motor 100 to contain pressure and transfer torque, radial, and thrust loads between the mounting interfaces of the output shaft 116 (e.g., the splines 122) and the mounting surfaces of the port block (e.g., the mounting flange 128).

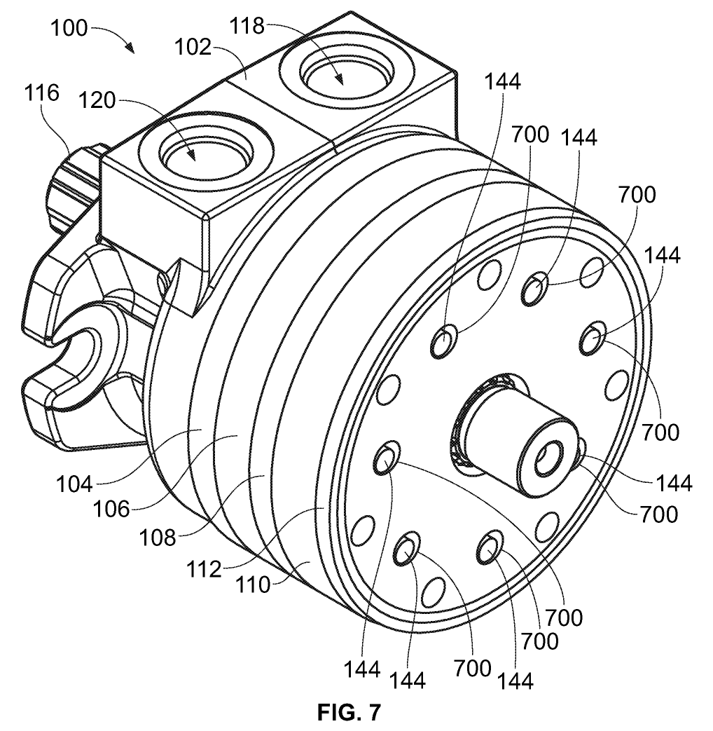

FIG. 8 illustrates an enlarged view of a portion of the cross-sectional view in FIG. 1C, according to an example implementation. In an example implementation, distal surface 800 of the wear plate 112 may be flat, while a proximal surface 802 of the locating ring 110 (interfacing with the distal surface 800) may be made to be slightly conical. Such a configuration prevents the bolt clamp load from deforming the components in such a way as to allow contact between the wear plate 112 and the orbit ring 138, the vanes 140, or the rotor 142. This may also alleviate tolerance or manufacturing accuracy issues.

Further, the hydraulic motor 100 may include a configuration that regulates pressure level if a case drain port of the hydraulic motor 100 is not drained to a reservoir (e.g., the fluid reservoir 121).

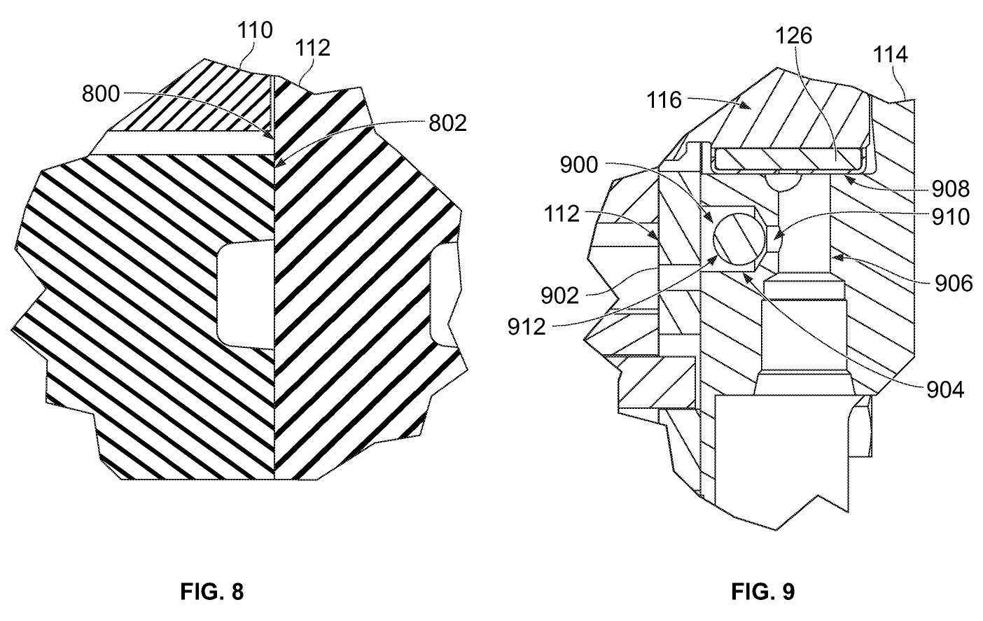

FIG. 9 illustrates another enlarged view of a portion of the cross-sectional view in FIG. 1C showing configuration of a check valve 900 in the end cover 114, according to an example implementation. Referring to FIGS. 5B, 6B, 9 together, the port 502g and the chamber 602g at the center bottom portion of the hydraulic motor 100 have fluid at a pressure level that changes with the rotation of the valve disk 146 (as do the other six ports and chambers).

The chamber 602g is exposed to a hole 902 formed in the in the wear plate 112, and the hole 902 is exposed to (e.g., partially overlaps with) a hole 904 in the end cover 114. The end cover may include a case drain port 906 that is fluidly coupled to a shaft cavity 908 (cavity in the end cover 114 that receives the second bearing 126 and the output shaft 116).

The end cover 114 also has a hole 910 having a smaller diameter than the hole 904. The check valve 900 includes a check ball 912 disposed in the hole 904 and configured to either block the hole 910 when seated or allow fluid communication between the hole 910 and the hole 904 when unseated. As such, the check ball 912 controls fluid flow between the hole 904 and the hole 910.

The case drain port 906 is a stagnate zone in the hydraulic motor 100. A stagnate or dead zone is an area where fluid flow either slows down significantly or stops entirely. In other words, it is an area that is characterized by reduced or no fluid movement.

In some hydraulic systems, the case drain port 906 could be coupled to the fluid reservoir 121, allowing the pressure in the stagnate zone to be relieved. However, in other systems, the case drain port 906 may be plugged, and thus pressure level may rise undesirably. Particularly, if the case drain port 906 is plugged or not drained, then leakage to the case drain port 906 may cause the pressure in the stagnate zone to increase, which is undesirable.

However, in the hydraulic motor 100, the check valve 900 prevents such rise in pressure. If pressure level in the chamber 602g exceeds the pressure in the stagnate zone, the check ball 912 is forced from the larger diameter of the hole 904 into the smaller diameter of the hole 910 (i.e., the check ball 912 is forced to a seated position) and prevents flow from the chamber 602g to the case drain port 906.

On the other hand, if the pressure level in the case drain port 906 exceeds the respective pressure level in chamber 602g, the check ball 912 is unseated. Thus, the hole 910 is unblocked, allowing fluid communication from the case drain port 906 into the chamber 602g.

With this configuration, pressure in the case drain port 906 (the stagnate zone) is regulated to prevent the pressure level in the stagnate zone from exceeding the pressure in the low-pressure return port (e.g., the second port 120). This pressure regulation configuration is effective regardless of which port (the first port 118 or the second port 120 in FIG. 1A) has the higher pressure, or which direction the output shaft 116 rotates. Advantageously, pressure regulation in both directions of rotation is controlled by a single check valve (the check valve 900) and a single hole (e.g., the hole 904).

Thus, the hydraulic motor 100 may provide several advantages over conventional hydraulic motors. Particularly, in conventional motors, there is a fixed inner ring that does not orbit, and the rotor interacts with such fixed inner ring, causing the rotor to rotate about its axis and orbit at the same. Thus, a drive link is needed to connect the rotor to the output shaft to compensate for the eccentricity resulting from the orbiting motion of the rotor.

With the configuration of the hydraulic motor 100 having the roller pins 144 and the orbit ring 138, the rotor 142 rotates about its own axis without orbiting. Thus, no drive link is needed, and the output shaft 116 is a through shaft that spans the length of the hydraulic motor 100. This allows the output shaft 116 to be properly supported by the bearings 124, 126, which are sufficiently spaced apart to enhance their load carrying capacity.

Notably, the roller pins 144 that control the orbit profile of the orbit ring 138 also absorb or carry torque load. Particularly, torque is transferred from output shaft 116 to the rotor 142, to the vanes 140 and the orbit ring 138, then to the roller pins 144, then the wear plates 108, 112 that support the roller pins 144, where the wear plates 108, 112 are bolted to the port block 102 (via the clamp bolts 134), then to the frame of the machine to which the hydraulic motor 100 is mounted via the mounting flange 128.

Further, the roller pins 144 are interposed or trapped between, and supported by, the wear plates 108, 112, where, at the distal ends, the roller pins 144 are disposed in the pockets 504 (blind holes) and, at the proximal ends, the roller pins 144 are disposed in the holes 700 (through-holes). As such, the roller pins 144 are supported on both ends thereof and also supported in the middle via the holes 604 in the orbit ring 138, so the roller pins 144 are balanced and there is no likelihood of tipping them.

Further, as described above with respect to FIG. 8, the distal surface 800 of the wear plate 112 may be flat, while a proximal surface 802 of the locating ring 110 may be made to be slightly conical, thereby preventing the bolt clamp load from deforming the components in such a way as to allow contact between the wear plate 112 and the orbit ring 138, the vanes 140, or the rotor 142. Also, as described with respect to FIG. 9, the hydraulic motor 100 includes a configuration that regulates pressure level if the case drain port 906 of the hydraulic motor 100 is not drained to a reservoir.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to those with skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.

EEE 1 is a hydraulic motor comprising: a first wear plate having a plurality of ports configured to be sequentially exposed to high pressure fluid and low pressure fluid, wherein the first wear plate has a plurality of pockets; a rotating group comprising: (i) an orbit ring having a plurality of vane pockets and a plurality of holes, (ii) a plurality of vanes respectively disposed in the plurality of vane pockets, and (iii) a rotor that is rotatably coupled to an output shaft and mounted within the orbit ring, wherein a plurality of chambers are formed between the orbit ring, the plurality of vanes, and the rotor, wherein high pressure fluid from a subset of ports in the first wear plate cause a first subset of chambers to expand, while a second subset of chambers contract, forcing low pressure fluid to flow into a corresponding subset of ports in the first wear plate; a second wear plate having a respective plurality of holes, wherein the rotating group is interposed between the first wear plate and the second wear plate; and a plurality of roller pins respectively mounted within the plurality of pockets of the first wear plate, through the plurality of holes in the orbit ring, and within the respective plurality of holes in the second wear plate, wherein expanding the first subset of chambers causes: (i) the orbit ring to orbit in a rotational direction, (ii) the rotor to rotate about an axis thereof in an opposite rotational direction, due to interaction of the rotor with the plurality of vanes as the orbit ring orbits, causing the output shaft to rotate, and (iii) the roller pins to roll within the plurality of pockets of the first wear plate, the plurality of holes in the orbit ring, and the respective plurality of holes in the second wear plate as the orbit ring orbits.

EEE 2 is the hydraulic motor of EEE 1, further comprising: a port block having a first port configured to receive the high pressure fluid from a source of fluid and a second port configured to discharge the low pressure fluid.

EEE 3 is the hydraulic motor of EEE 2, wherein the port block further comprises: a first fluid gallery that is fluidly coupled to the first port; and a second fluid gallery that is fluidly coupled to the second port, wherein the high pressure fluid is provided to the first fluid gallery then to the subset of ports of the plurality of ports of the first wear plate, and wherein the low pressure fluid returns through the second fluid gallery to the second port.

EEE 4 is the hydraulic motor of EEE 3, wherein the port block further comprises multiple concentric rings formed therein, wherein the first fluid gallery and the second fluid gallery are formed in respective annular spaces between the multiple concentric rings.

EEE 5 is the hydraulic motor of any of EEEs 1-4, further comprising: a valve disk mounted to, and rotatable with, the output shaft, wherein the valve disk has a first set of windows configured to receive the high pressure fluid, and a second set of windows configured to return the low pressure fluid, wherein as the valve disk rotates, the first set of windows and the second set of windows pass in front of the plurality of ports of the first wear plate in a sequential manner such that each port of the plurality of ports is sequentially exposed to the high pressure fluid, then neutral pressure fluid, then the low pressure fluid.

EEE 6 is the hydraulic motor of EEE 5, wherein: the first set of windows is disposed in a circular array in the valve disk; and the second set of windows is disposed in a circular array in the valve disk, wherein the first set of windows are interleaved with the second set of windows.

EEE 7 is the hydraulic motor of any of EEEs 5-6, wherein respective windows of the first set of windows are longer in a radial direction compared to respective windows of the second set of windows.

EEE 8 is the hydraulic motor of EEE 7, further comprising: a port block having a first port configured to receive the high pressure fluid from a source of fluid and a second port configured to discharge the low pressure fluid; and a third wear plate interfacing with the valve disk, wherein the third wear plate comprises a first set of slots that are fluidly coupled to the first port of the port block, and a second set of slots that are formed radially inward from the first set of slots and are fluidly coupled to the second port, wherein the first set of windows of the valve disk are fluidly coupled to the first set of slots due to being longer in the radial direction, wherein the second set of windows of the valve disk are fluidly coupled to the second set of slots.

EEE 9 is the hydraulic motor of EEE 8, wherein the valve disk is mounted within a spacer that is interposed between the third wear plate and the first wear plate.

EEE 10 is the hydraulic motor of any of EEEs 5-9, wherein respective windows of the first set of windows are tee-shaped.

EEE 11 is the hydraulic motor of any of EEEs 5-10, wherein the first set of windows of the valve disk are “n” number of windows, wherein the second set of windows of the valve disk are “n” number of windows, and wherein the plurality of ports of the first wear plate are “n+1” ports.

EEE 12 is the hydraulic motor of any of EEEs 1-11, wherein the plurality of pockets of the first wear plate are configured as blind holes.

EEE 13 is the hydraulic motor of any of EEEs 1-12, wherein the plurality of holes of the second wear plate are through-holes.

EEE 14 is the hydraulic motor of any of EEEs 1-13, wherein a diameter of each roller pin of the plurality of roller pins is consistent along a length thereof, wherein respective diameters of the plurality of pockets of the first wear plate, the plurality of holes in the orbit ring, and the respective plurality of holes in the second wear plate are the same and are all equal to a sum of the diameter of the roller pin and an eccentricity of an orbiting profile of the orbit ring relative to the axis of the rotor and the output shaft.

EEE 15 is the hydraulic motor of EEE 14, wherein the plurality of roller pins are each configured to roll within the plurality of pockets of the first wear plate, the plurality of holes in the orbit ring, and the respective plurality of holes in the second wear plate without sliding.

EEE 16 is the hydraulic motor of any of EEEs 1-15, wherein at least one port of the plurality of ports of the first wear plate is exposed to a neutral pressure fluid that is neither the high pressure fluid nor the low pressure fluid.

EEE 17 is the hydraulic motor of EEE 16, wherein a chamber of the plurality of chambers is fluidly coupled to the at least one port, wherein the second wear plate has a first hole that is fluidly coupled to the chamber, and wherein the hydraulic motor further comprises: an end cover interfacing with the second wear plate, wherein the end cover has (i) a second hole that is fluidly coupled to the first hole of the second wear plate, (ii) a third hole having a smaller diameter compared to the second hole, (iii) a case drain port that is fluidly coupled to the third hole, and (iv) a check ball that controls fluid flow between the second hole and the third hole.

EEE 18 is the hydraulic motor of EEE 17, wherein: when pressure level in the at least one port, the chamber, the first hole, and the second hole is greater than pressure level in the case drain port, the check ball blocks flow to the third hole and the case drain port, preventing pressure level from increasing in the case drain port, and when pressure level in the at least one port, the chamber, the first hole, and the second hole is less than pressure level in the case drain port, the check ball allows relieving fluid from the case drain port through the third hole to the second hole, the first hole, the chamber, and the at least one port.

EEE 19 is the hydraulic motor of any of EEEs 1-18, further comprising: a locating ring within which the rotating group is disposed, wherein the locating ring is interposed between the first wear plate and the second wear plate, wherein a distal surface of the second wear plate is flat, and wherein a proximal surface of the locating ring interfacing with the distal surface of the second wear plate is conical.

EEE 20 is the hydraulic motor of any of EEEs 1-19, further comprising: a port block mounted distal to the first wear plate; an end cover interfacing with, and mounted proximal to, the second wear plate, wherein the output shaft extends from the port block through the first wear plate, the rotating group, and the second wear plate to the end cover; a first bearing mounted within the port block and supporting the output shaft; and a second bearing mounted within the end cover and supporting the output shaft.

EEE 21 is the hydraulic motor of EEE 20, wherein the second wear plate is integrated into the end cover.

EEE 22 is a hydraulic motor comprising: a wear plate having a plurality of ports configured to be sequentially exposed to high pressure fluid and low pressure fluid, wherein the wear plate has a plurality of pockets; a rotating group comprising: (i) an orbit ring having a plurality of vane pockets and a plurality of holes, (ii) a plurality of vanes respectively disposed in the plurality of vane pockets, and (iii) a rotor that is rotatably coupled to an output shaft and mounted within the orbit ring, wherein a plurality of chambers are formed between the orbit ring, the plurality of vanes, and the rotor, wherein high pressure fluid from a subset of ports in the wear plate cause a first subset of chambers to expand, while a second subset of chambers contract, forcing low pressure fluid to flow into a corresponding subset of ports in the wear plate; and a plurality of roller pins respectively mounted within the plurality of pockets of the wear plate and through the plurality of holes in the orbit ring, wherein expanding the first subset of chambers causes: (i) the orbit ring to orbit in a rotational direction, (ii) the rotor to rotate about an axis thereof in an opposite rotational direction, due to interaction of the rotor with the plurality of vanes as the orbit ring orbits, causing the output shaft to rotate, and (iii) the roller pins to roll within the plurality of pockets of the first wear plate and the plurality of holes in the orbit ring.

What is claimed is:

1. A hydraulic motor comprising:
a first wear plate having a plurality of ports configured to be sequentially exposed to high pressure fluid and low pressure fluid, wherein the first wear plate has a plurality of pockets;
a rotating group comprising: (i) an orbit ring having a plurality of vane pockets and a plurality of holes, (ii) a plurality of vanes respectively disposed in the plurality of vane pockets, and (iii) a rotor that is rotatably coupled to an output shaft and mounted within the orbit ring, wherein a plurality of chambers are formed between the orbit ring, the plurality of vanes, and the rotor, wherein high pressure fluid from a subset of ports in the first wear plate cause a first subset of chambers to expand, while a second subset of chambers contract, forcing low pressure fluid to flow into a corresponding subset of ports in the first wear plate;
a second wear plate having a respective plurality of holes, wherein the rotating group is interposed between the first wear plate and the second wear plate; and
a plurality of roller pins respectively mounted within the plurality of pockets of the first wear plate, through the plurality of holes in the orbit ring, and within the respective plurality of holes in the second wear plate, wherein expanding the first subset of chambers causes: (i) the orbit ring to orbit in a rotational direction, (ii) the rotor to rotate about an axis thereof in an opposite rotational direction, due to interaction of the rotor with the plurality of vanes as the orbit ring orbits, causing the output shaft to rotate, and (iii) the roller pins to roll within the plurality of pockets of the first wear plate, the plurality of holes in the orbit ring, and the respective plurality of holes in the second wear plate as the orbit ring orbits.

2. The hydraulic motor of claim 1, further comprising:
a port block having a first port configured to receive the high pressure fluid from a source of fluid and a second port configured to discharge the low pressure fluid.

3. The hydraulic motor of claim 2, wherein the port block further comprises:
a first fluid gallery that is fluidly coupled to the first port; and
a second fluid gallery that is fluidly coupled to the second port, wherein the high-pressure fluid is provided to the first fluid gallery then to the subset of ports of the plurality of ports of the first wear plate, and wherein the low-pressure fluid returns through the second fluid gallery to the second port.

4. The hydraulic motor of claim 3, wherein the port block further comprises multiple concentric rings formed therein, wherein the first fluid gallery and the second fluid gallery are formed in respective annular spaces between the multiple concentric rings.

5. The hydraulic motor of claim 1, further comprising:
a valve disk mounted to, and rotatable with, the output shaft, wherein the valve disk has a first set of windows configured to receive the high pressure fluid, and a second set of windows configured to return the low pressure fluid, wherein as the valve disk rotates, the first set of windows and the second set of windows pass in front of the plurality of ports of the first wear plate in a sequential manner such that each port of the plurality of ports is sequentially exposed to the high pressure fluid, then neutral pressure fluid, then the low pressure fluid.

6. The hydraulic motor of claim 5, wherein:
the first set of windows is disposed in a circular array in the valve disk; and
the second set of windows is disposed in a circular array in the valve disk, wherein the first set of windows are interleaved with the second set of windows.

7. The hydraulic motor of claim 5, wherein respective windows of the first set of windows are longer in a radial direction compared to respective windows of the second set of windows.

8. The hydraulic motor of claim 7, further comprising:
a port block having a first port configured to receive the high pressure fluid from a source of fluid and a second port configured to discharge the low pressure fluid; and
a third wear plate interfacing with the valve disk, wherein the third wear plate comprises a first set of slots that are fluidly coupled to the first port of the port block, and a second set of slots that are formed radially inward from the first set of slots and are fluidly coupled to the second port, wherein the first set of windows of the valve disk are fluidly coupled to the first set of slots due to being longer in the radial direction, wherein the second set of windows of the valve disk are fluidly coupled to the second set of slots.

9. The hydraulic motor of claim 8, wherein the valve disk is mounted within a spacer that is interposed between the third wear plate and the first wear plate.

10. The hydraulic motor of claim 5, wherein respective windows of the first set of windows are tee-shaped.

11. The hydraulic motor of claim 5, wherein the first set of windows of the valve disk are “n” number of windows, wherein the second set of windows of the valve disk are “n” number of windows, and wherein the plurality of ports of the first wear plate are “n+1” ports.

12. The hydraulic motor of claim 1, wherein the plurality of pockets of the first wear plate are configured as blind holes.

13. The hydraulic motor of claim 1, wherein the plurality of holes of the second wear plate are through-holes.

14. The hydraulic motor of claim 1, wherein a diameter of each roller pin of the plurality of roller pins is consistent along a length thereof, wherein respective diameters of the plurality of pockets of the first wear plate, the plurality of holes in the orbit ring, and the respective plurality of holes in the second wear plate are the same and are all equal to a sum of the diameter of the roller pin and an eccentricity of an orbiting profile of the orbit ring relative to the axis of the rotor and the output shaft.

15. The hydraulic motor of claim 14, wherein the plurality of roller pins are each configured to roll within the plurality of pockets of the first wear plate, the plurality of holes in the orbit ring, and the respective plurality of holes in the second wear plate without sliding.

16. The hydraulic motor of claim 1, wherein at least one port of the plurality of ports of the first wear plate is exposed to a neutral pressure fluid that is neither the high pressure fluid nor the low pressure fluid.

17. The hydraulic motor of claim 16, wherein a chamber of the plurality of chambers is fluidly coupled to the at least one port, wherein the second wear plate has a first hole that is fluidly coupled to the chamber, and wherein the hydraulic motor further comprises:
an end cover interfacing with the second wear plate, wherein the end cover has (i) a second hole that is fluidly coupled to the first hole of the second wear plate, (ii) a third hole having a smaller diameter compared to the second hole, (iii) a case drain port that is fluidly coupled to the third hole, and (iv) a check ball that controls fluid flow between the second hole and the third hole.

18. The hydraulic motor of claim 17, wherein:
when pressure level in the at least one port, the chamber, the first hole, and the second hole is greater than pressure level in the case drain port, the check ball blocks flow to the third hole and the case drain port, preventing pressure level from increasing in the case drain port, and
when pressure level in the at least one port, the chamber, the first hole, and the second hole is less than pressure level in the case drain port, the check ball allows relieving fluid from the case drain port through the third hole to the second hole, the first hole, the chamber, and the at least one port.

19. The hydraulic motor of claim 1, further comprising:
a locating ring within which the rotating group is disposed, wherein the locating ring is interposed between the first wear plate and the second wear plate, wherein a distal surface of the second wear plate is flat, and wherein a proximal surface of the locating ring interfacing with the distal surface of the second wear plate is conical.

20. The hydraulic motor of claim 1, further comprising:
a port block mounted distal to the first wear plate;
an end cover interfacing with, and mounted proximal to, the second wear plate, wherein the output shaft extends from the port block through the first wear plate, the rotating group, and the second wear plate to the end cover;
a first bearing mounted within the port block and supporting the output shaft; and
a second bearing mounted within the end cover and supporting the output shaft.
